(19) United States
(12) Patent Application Publication
(10) Pub. No.: US 2004/0241271 A1
(43) Pub. Date: Dec. 2, 2004

(54) Extruder for making a board based on a binder such as gypsum plaster

(76) Inventors: Christian Derusco, Acheres (FR); Parice Bouscal, Saint Maur Des Fosses (FR); Frederic Chantereau, Courbevoie (FR)

Correspondence Address: YOUNG & THOMPSON, 745 SOUTH 23RD STREET, 2ND FLOOR, ARLINGTON, VA, 22202, US

(21) Appl. No.: 10/479,964

(22) PCT Filed: Jun. 6, 2002
(86) PCT No.: PCT/FR02/01930

(30) Foreign Application Priority Data
Jun. 7, 2001 (FR) 01/07466

(51) Int. Cl. B29C 47/16; B28B 1/08; B28B 11/16; B28B 21/52

(52) U.S. Cl. 425/380; 264/70; 264/148; 264/146; 442/1

(57) ABSTRACT

Method for making a board based on a binder comprises: a mixing a composition designed to form the board body with water; b) depositing the mixture on a moving support the mixture passing through an extruder forming a board, the extruder being subjected to vibrations; c) cutting the resulting board at least lengthwise. The extruder comprises a transverse extruding die (40) provided with an upper lip and a lower lip (38) which bears on its lower surface at least a vibrator (42). The invention further concerns a board based on a binder produced by the method and the use of such board, wherein the binder is cementitious, or based on gypsum plaster.

The present invention relates to boards based on binders such as plaster, cement or other binders.

In the present context, the term “board” means a thin and globally flat product whose height is small compared to the other two dimensions, whether the cross section is rectilinear or not, for example crenellated, sinusoidal, such as a corrugated sheet, or otherwise.

An object of the present invention is to propose a low-cost method of producing such boards, in particular because it is executed continuously.

Accordingly, a method in accordance with the invention of producing a board based on binders such as plaster, cement or other binders is characterized in that it includes the steps of:

a) mixing a composition intended to form the board body with water;

b) depositing the mixture on a moving support, which is driven continuously by a conveyor belt, said mixture passing through an extruder forming a board, said extruder being subjected to vibrations;

c) cutting the board obtained at least to length.

In step c), the board is advantageously cut to length and to width.

The deposition of step b) is preferably carried out on a bottom facing; the deposit of step b) is covered with a top facing.

The facing advantageously consists of a mesh and/or a web.

The mesh is preferably of glass fibers.

The web advantageously covers the mesh over the whole of its width; alternatively, the web is in the form of a strip and covers only the lateral edges of the mesh.

The web is preferably a mat, preferably of glass fibers.

In step c), the cutting method is advantageously cutting with a water jet.

The lateral edges of the boards are formed beforehand by turning over the bottom mesh and then cut straight; the turned over portion of the bottom mesh is covered by the top mesh whether or not it is associated with a web; alternatively, the turned over portion of the bottom mesh covers the top mesh whether or not it is associated with a web.

At least the lateral edges of the bottom mesh are preferably associated with a web.

When the edges are cut straight, the cutting is advantageously effected in the overlapping portion.

In another embodiment, operation b) is carried out in such a way that two of the lateral edges of the boards are thinner.

Alternatively the top and/or bottom facing is of cardboard, substituted for the mesh and/or the web.

The invention also consists in an extruder for implementing the above method, of the kind including a transverse extrusion die, characterized in that said die is at least in part subjected to vibrations.

The die advantageously has a top lip and a bottom lip which carries on its bottom face at least one vibrator; the distance between the top lip and the bottom lip of the die is adjustable.

The axis of the vibrator can preferably be oriented horizontally and/or vertically.

The extrusion die advantageously has a generally rectangular shape with the ends of the facing lengths converging slightly in the outward direction.

The present invention also consists in a board based on a binder such as plaster or cement, characterized in that it is made by the above method.

The present invention also consists in using the above board, in which the binder is a cementitious binder, to form or cover walls, partition walls, floors or roofs, inside or outside buildings, such as industrial kitchens, agriculture-foodstuffs laboratories, showers, bathrooms, pools or swimming pools, and/or rooms frequently washed with a water jet, such as rooms of agricultural buildings or industrial slaughterhouses, and using the above board, in which the binder is based on plaster, to form or cover walls or partition walls.

The present invention will be explained in more detail with the aid of the following illustrative but nonlimiting examples, which refer to the drawings, in which:

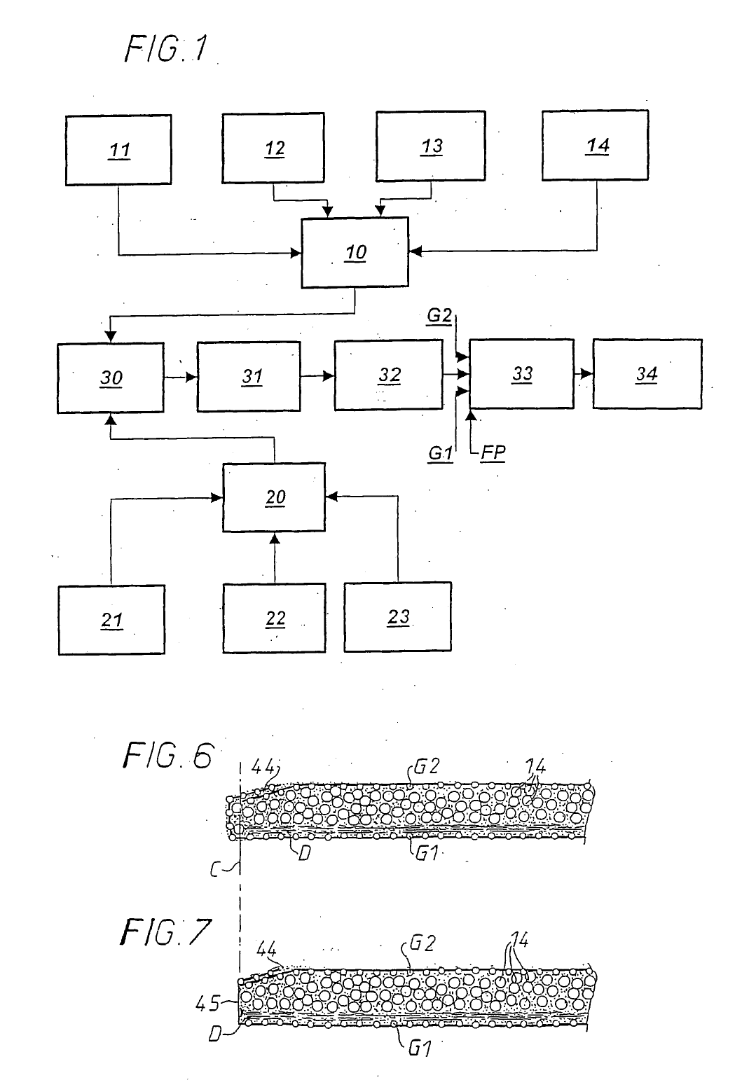

FIG. 1 is a diagram representing a method according to the invention;

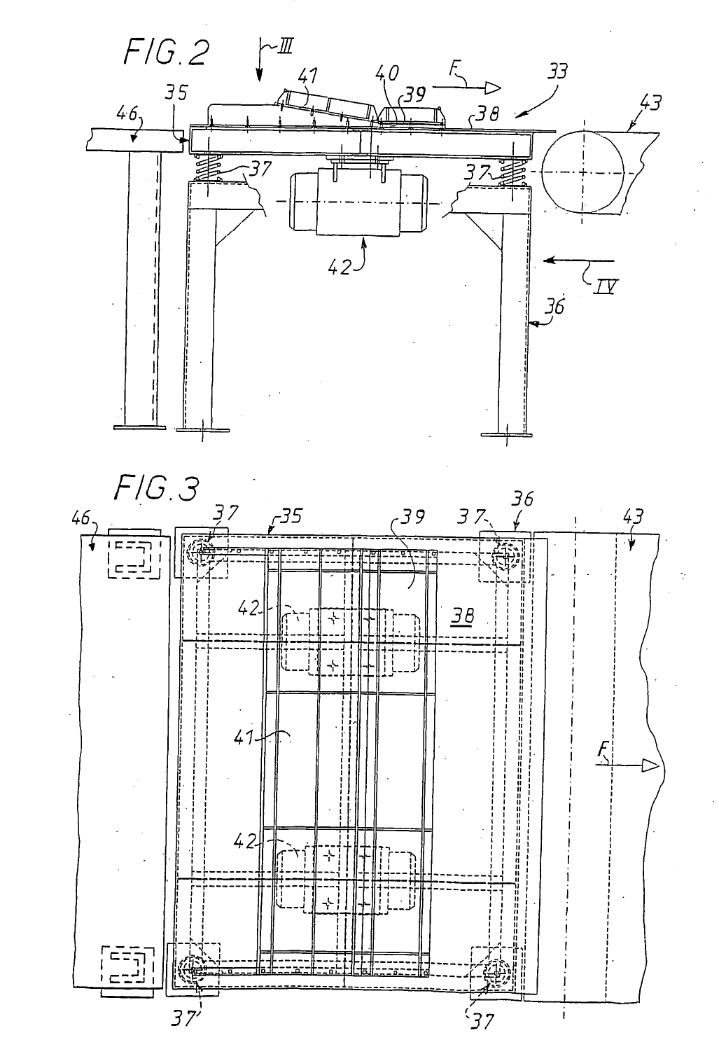

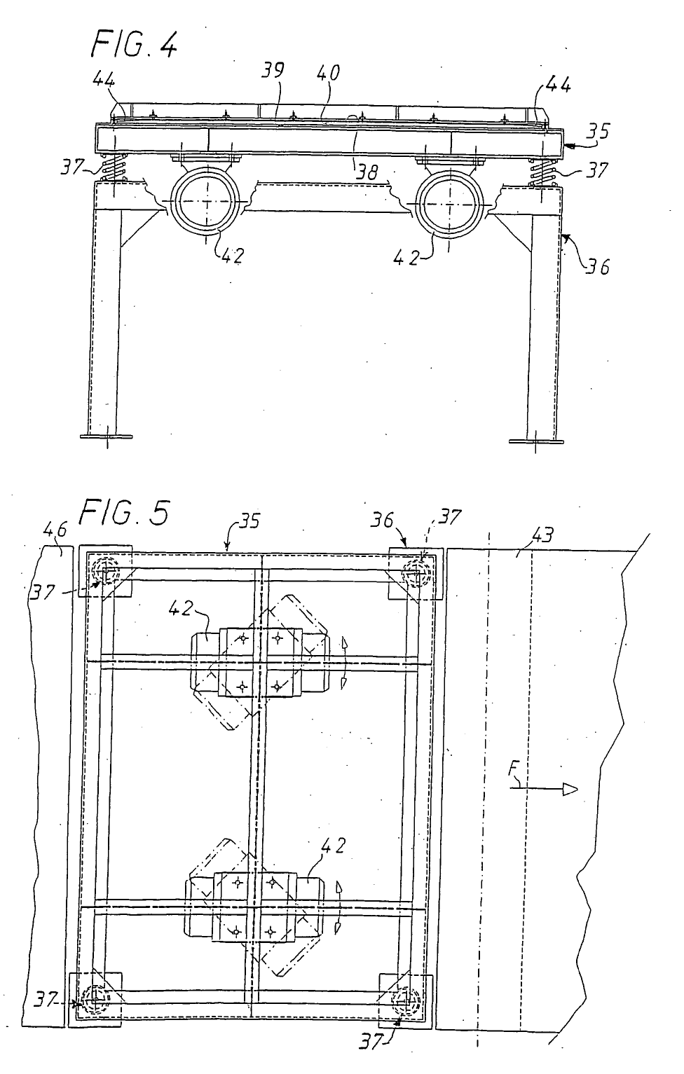

FIGS. 2 to 4 show an extruder used in the method according to the invention, FIG. 2 being a view in elevation and FIGS. 3 and 4 being views in the direction of the arrows III and IV in FIG. 2, respectively;

FIG. 5 is a view analogous to FIG. 3 and shows a variant;

FIG. 6 is a partial sectional view of a board in accordance with the invention before cutting its longitudinal edges;

FIG. 7 is a partial sectional view of a board in accordance with the invention after cutting its longitudinal edges along the line C in FIG. 6;

FIGS. 8 to 17 are diagrammatic views analogous to FIG. 6 each showing one variant of a board before cutting its longitudinal edges.

The binder of the board body comprises a mixture of Portland cement, sulfoaluminous clinker and a source of calcium sulfate (anhydrite, plaster or gypsum).

The expression “Portland cement” means a cement of type I, II, III, IV or V as standardized under European standard EN 197-1. Examples of such cements are ordinary Portland cement and any other cement with additives (composite Portland, pozzolanic, blast furnace, slag or ash cement).

The above examples of cements have approximate Blaine specific surface areas from 3700 cm²/g to 5050 cm²/g.

The Portland cement content of the binder can vary from 30 to 80%. Throughout this range, it is possible to obtain quick setting formulations (setting time less than 20 minutes). A preferred range is from 50 to 70%, which yields optimum mechanical performance.

The expression “sulfoaluminous clinker” means any material resulting from the curing at a temperature from 900° C. to 1450° C. (this process is known as “clinkerization”) of mixtures containing at least one source of lime (for example limestone, which has a CaO content varying from 50% to 60%), at least one source of alumina (for example bauxites or other fabrication byproducts containing alumina), and at least one source of sulfate (gypsum, chemical gypsums, plaster, natural or synthetic anhydrite, sulfocalcic ash). The sulfoaluminous clinker used in the present invention contains more than 30% of 4CaO.3Al₂O₃.SO₃ (also denoted C₄A₃\overline{S}). The basic analyses and the main constituents of two usable types of sulfoaluminous clinker, characterized by respective contents of C₄A₃\overline{S} greater than 47%, are set out in tables I and II below:

TABLE I

| OXIDE | CLINKER 1 | CLINKER 2 |
|---|---|---|
| SiO₂ | 3.6% | 7.6% |
| Al₂O₃ | 45.3% | 27.9% |
| Fe₂O₃ | 0.9% | 7.0% |
| CaO | 37.0% | 45.1% |
| SO₃ | 7.8% | 7.9% |
| TiO₂ | 2.6% | 2.2% |
| Other | 2.8% | 2.3% |

TABLE II

| CONSTITUENT | CLINKER 1 | CLINKER 2 |
|---|---|---|
| C₄A₃\overline{S} | 60% | 47% |
| CA, CA₂, C₁₂A₇ | 14% | — |
| C₂S | — | 22% |
| C₂AS | 17% | — |
| C\overline{S} | — | 3% |
| C₄AF | 3% | 22% |
| CT | 4% | 4% |
| Other | 2% | 2% |

The presence of up to 10% of free lime CaO in the sulfoaluminous clinker can be tolerated without compromising the usage properties of the binder employed in the context of the present invention. This can arise, for example, if the clinker is obtained by curing at relatively low temperature.

The content of sulfoaluminous clinker in the binder can vary from 20% to 70%.

If the Blaine specific surface area of the sulfoaluminous clinker is from 2500 cm²/g to 7000 cm²/g, and in particular from 3500 to 6500 cm²/g, the hydration kinetics of the binder are not significantly modified, and achieve rapid setting and hardening.

The sulfate source can be chosen at will from gypsum (or chemical gypsums), plaster, natural or synthetic anhydrite or sulfocalcic ash. The content of SO₃ coming from the sulfate source can be up to 10% by mass of the total binder (which corresponds, for example, to a plaster content of up to 20% relative to the total binder). A preferred composition is one such that the contribution of sulfate is such that the mass ratio r defined above is close to 2. It is precisely in this case that the stoichiometric conditions of formation of ettringite are complied with:

C₄A₃\overline{S}+2C\overline{S}H_{0.5}+37H→C₆A\overline{S}₃H₃₂+2AH₃

This preferred composition guarantees increased durability of the boards. In fact, the absence of sulfate leads to the formation of calcium monosulfoaluminate C₄A\overline{S}Hₓ that is unstable vis à vis sulfated water, for example, leading a posteriori to the formation of expansive ettringite. On the other hand, an excess of sulfate can lead to instability of thin products vis à vis moisture.

If the priority is very short term mechanical strength, the preferred sulfate of the invention is plaster. If the priority is plasticity, the preferred sulfate is anhydrite.

In relation to the composition of the binder with additives, the term “(super)plasticizer” must be understood to include any organic compound capable of improving the usability (or workability) of light mortar. In the case of the present invention, it can also achieve a significant water reduction, for the same workability, and this contributes to obtaining higher mechanical performance for the production of lightweight boards.

According to the EN 934-2: 1997 standard, a water reducer additive reduces the quantity of water necessary by at least 5% relative to a cement composition with no additives, and a high water reducer additive reduces the quantity of water necessary by at least 12% relative to a cement composition with no additives.

The (high) water reducer (super)plasticizer additives used can be alkaline (Li, Na, K) salts or alkaline earth (Ca, Mg) salts obtained from combined condensation of β-naphthalene sulfonic acid and formaldehyde (of the Cimfluid 230 or 232 type from Axim, Ciments Francais), from combined condensation of sulfonated melamine and formaldehyde (Cimfluid ML type from Axim, Ciments Francais) or lignosulfonates.

A preferred additive in the context of the present invention is the alkaline or alkaline earth salt obtained from combined condensation of sulfonated melamine and formaldehyde (Cimfluid ML type), which achieves high fluidity and causes no significant retardation of setting despite the high doses used.

The Cimfluid ML content varies from 0.5 to 7% (percentage by mass relative to the weight of the binder).

Any mineral or organic compound that significantly extends the setting time of a mortar formulation without compromising its rheology is generally considered to constitute a setting retarder. This is known in the art. The benefit of this kind of additive lies in the possibility of controlling the setting of the formulation, and where applicable of retarding setting, to facilitate good workability. Preferred retarders are citric acid, gluconates and polyacrylates or polymethacrylates (of the Cimfluid 2000 AC type), which also significantly improve the workability of the paste.

It is obvious that the ideal formulation results from a compromise between the water content, the (high) water reducer (super)plasticizer content, and the retarder content, to obtain the required workability, time of use and mechanical performance. The water/binder ratio by weight used is generally from 0.2 to 0.5. Beyond this range mechanical performance falls off vertiginously. For a water/binder ratio by weight of less than 0.2, there is insufficient water for the reactions constituting hydration of the binder; surplus anhydrite binder can then remain, and can compromise the durability of the material in a damp environment. The water/binder ratio used is preferably from 0.25 to 0.40.

### EXAMPLES

Preparation of a Board Body Composition According to the Invention:

The formulation of the base is as follows (composition 1):

| | |
|---|---|
| CPA CEM I 52.5 | 60 g |
| Sulfoaluminous clinker (1) | 30 g |
| Gypsum | 10 g |
| Additive | x g |
| Total water | 30 g |
| (including that in the additives) | |

Performance differences of the above base cement composition on varying the relative proportions x and the nature of the additives were studied, using the compositions of examples 1, 5, 7, 10 and 12 described below.

The following measurements are effected on the above compositions:

Measurement of time of use: The procedure consists in tracking the rheological behavior of the composition as a function of time when undergoing continuous mixing at an imposed speed of 300 rpm. The time of use is then defined as the time at which the measured resisting torque is equal to 0.05 N.m. The calculated parameter Δt₂ corresponds to the time necessary for the measured resisting torque to increase from 0.05 N.m to 0.1 N.m. It takes account of the rate of hardening of the composition: the shorter this time, the higher the rate of hardening.

Measurement of initial spreading: The procedure consists in effecting a rheological measurement 1 minute 20 seconds after mixing using a Smidth ring with the following dimensions: inside diameter=60 mm, height=50 mm. The paste is mixed for 40 seconds at 250 rpm and the spreading measurement is effected after 1 minute 20 seconds.

Measurement of setting time: The procedure adopted consists in measuring, as a function of time, the resistance to the penetration of a cylindrical needle with a diameter of 3 mm into the formulation under test using the TA XT2 texture meter from Société Rhéo. The rate and distance of penetration are respectively fixed at 2 mm/s and 10 mm depth. The measured start and end of setting times respectively correspond to the times necessary to obtain a force of 10 N and of 50 N at a depth of 10 mm. In contrast to the measurement of the time of use, the measurement of the setting time is effected at rest without disturbing the sample during setting by mixing it. The calculated parameter Δt₁ corresponds to the time necessary for the measured force to increase from 10 N to 50 N. It takes account of the rate of hardening of the composition: the shorter this time, the higher the rate of hardening.

The various compositions studied are described below:

### Example 1

This composition contains only the base formulation and the Cimfluid ML superplasticizer:

| AD- | | | START OF | END OF | | |
|---|---|---|---|---|---|---|
| DITIVE | | TIME OF | SETTING | SETTING | | |
| x(g) | SPREAD | USE | TIME | TIME | Δt₁ | Δt₂ |
| ML* | (mm) | (min) | (min) | (min) | (min) | (min) |
| 2 | 146 | 6.8 | 14.0 | 21.5 | 7.5 | 2.0 |
| 4 | — | 18.0 | 14.8 | 25.6 | 10.8 | 3.3 |
| 8 | — | 17.0 | 16.5 | 27.0 | 10.5 | 3.6 |

*ML = Cimfluid ML,
(—): not measured

A value of 60 mm corresponds to a zero spread (the diameter of the cone used for the measurement).

The Cimfluid ML superplasticizer used on its own yields satisfactory results.

The following examples 2 to 6 also used the Cimfluid ML superplasticizer on its own.

### Example 2

### Comparison of Two Uses of a Sulfoaluminous Clinker with Different Contents of Calcium Sulfoaluminate C₄A₃\overline{S}.

The formulations studied were as follows:

COMPOSITION

| | 2a | 2b |
|---|---|---|
| CEM I 52.5 | 60 g | 50 g |
| Sulfoaluminous | Type 1 (table I) | Type 2 (table I) |
| clinker | 30 g | 43 g |
| C₄A₃\overline{S} content of | 56% | 35% |
| clinker | | |
| Plaster | 10 g | 7 g |
| Additive = | 2 g | 2 g |
| Cimfluid ML | | |
| Water | 30 g | 30 g |

The start of setting times measured for the compositions 2a and 2b are 6 minutes and 7 minutes 50 seconds, respectively. The composition 2a has a ratio r equal to 2.48.

### Example 3

This example shows the effects on the start and end of setting times of the Portland cement content of the binder, with a plaster content maintained constant and equal to 10%, the remainder to 100% being sulfoaluminous clinker. These tests are carried out in the presence of 2% Cimfluid ML and in the absence of lightweight aggregates, the water/binder mass ratio being 0.30.

The following table shows that for Portland cement contents from 36 to 76% the start of setting time is 10 minutes or less.

| AMOUNT | | |
|---|---|---|
| OF PORTLAND | START OF SETTING | END OF SETTING |
| CEMENT IN BINDER (%) | TIME (min) | TIME (min) |
| 36 | 10 | 13 |
| 54 | 6 | 8 |
| 60 | 6 | 8 |
| 68 | 7 | 9 |
| 76 | 8 | 10 |

### Example 4

2 g of expanded polystyrene balls were added to a of example 2.

The measurements of setting times and of mechanical resistance to flexing (Rf) and compression (Rc) were carried out on (4×4×16) cm³ samples with a specific gravity equal to 1, after 20 minutes, 60 minutes and 24 hours. The values obtained are set out in the table below:

| MEASUREMENT | VALUE |
|---|---|
| SPECIFIC GRAVITY (at 20 min) | 1 |
| Rf (at 20 min) | 0.9 MPa |
| Rc (at 20 min) | 2.50 MPa |
| Rf (at 60 min) | 1.20 MPa |
| Rc (at 60 min) | 3.40 MPa |
| Rf (at 24 hours) | 1.80 MPa |
| Rc (at 24 hours) | 8.80 MPa |

### Example 5

Mechanical resistance to flexing (Rf) and compression (Rc) were measured on (4×4×16) cm³ samples after 24 hours With a formulation identical to that of example 4, but with the Portland cement content varying. The results are set out in the table below:

| PORTLAND CEMENT | SPECIFIC | 24 hours | |
|---|---|---|---|
| CONTENT (%) | GRAVITY | Rf (MPa) | Rc (MPa) |
| 47 | 0.98 | 1.6 | 10.2 |
| 60 | 1.00 | 1.8 | 8.8 |
| 63 | 1.01 | 2.1 | 9.0 |
| 66 | 0.99 | 1.7 | 8.3 |
| 68 | 0.99 | 1.7 | 8.3 |

### Example 6

### Use of Portland Cement and Sulfoaluminous Clinker with Different Blaine Specific Surface Areas

The formulation studied in all cases is the previous composition 2a to which polystyrene balls were added to obtain a specific gravity very close to 1. The influence of the Blaine specific surface area of the Portland cement and that of the sulfoaluminous clinker on the very short term mechanical performance were studied.

| | Blaine | | t = 20 minutes | | t = 24 hours | |
|---|---|---|---|---|---|---|
| | specific | | | Com- | | Com- |
| | surface | | Flexing | pression | Flexing | pression |
| | area | Specific | Rf | Rc | Rf | Rc |
| | (cm²/g) | gravity | (MPa) | (MPa) | (MPa) | (MPa) |
| Portland | | | | | | |
| cement | | | | | | |
| CEM I (*) | | | | | | |
| 6a | 3720 | 0.95 | 1.0 | 3.1 | 1.9 | 8.7 |
| 6b | 4050 | 1.01 | 0.9 | 3.5 | 1.9 | 8.4 |
| 6c | 4420 | 0.95 | 0.9 | 3.2 | 1.9 | 7.4 |
| 6d | 5040 | 1.01 | 0.9 | 3.5 | 1.8 | 7.0 |
| Sulfoaluminous | | | | | | |
| cement (**) | | | | | | |
| 6e | 3800 | 0.95 | 1.1 | 3.1 | 1.9 | 8.7 |
| 6f | 4500 | 1.02 | 1.2 | 2.9 | 1.9 | 9.8 |
| 6g | 5000 | 0.98 | 0.9 | 3.2 | 2.0 | 9.7 |

(*): the specific surface area of the sulfoaluminous clinker used is equal to 4500 cm²/g
(**): the specific surface area of the sulfoaluminous clinker used is equal to 3720 cm²/g

In the specific surface area range studied (3500-5500 cm²/g), whether in the case of sulfoaluminous clinker or Portland cement, the hydration kinetics of the composition 2a are not significantly modified, as indicated by the similar mechanical performance obtained.

### Example 7

The two additives, i.e. the superplasticizer (Cimfluid ML) and the poly(meth)acrylate retarder (Cimfluid AC) are used simultaneously in the cement base composition at contents set out in the table below:

| | | | | START | | | |
|---|---|---|---|---|---|---|---|
| | | | TIME | OF | END OF | | |
| ADDITIVE | | | OF | SETTING | SETTING | | |
| x(g) | | SPREAD | USE | TIME | TIME | Δt₁ | Δt₂ |
| ML* | AC* | (mm) | (min) | (min) | (min) | (min) | (min) |
| 2 | 0.3 | 156 | 16.5 | — | — | — | 2.1 |
| 2 | 0.6 | 202 | 26.3 | — | — | — | 2.2 |
| 2 | 1 | 217 | 32.2 | 14.2 | 25.5 | 11.3 | 2.2 |

*ML = Cimfluid ML,
*AC = Cimfluid 2000 AC

The use of 2% of Cimfluid ML obtains a rapid setting and rapid hardening cement formulation usable in the context of fabrication of thin lightweight cement-based products.

The use of Cimfluid 2000 AC, at contents of up to 1% in this example, controls the time of use of the basic composition (containing 2% of Cimfluid ML), which can be up to approximately 30 minutes. Moreover, this addition increases the initial workability of the composition without significantly modifying the start and end of setting times. The values of Δt₁ and Δt₂ show that, even with 1% of Cimfluid 2000 AC, the rate of hardening is only slightly lower.

### Example 8

With a formulation identical to that of the composition of example 4, with a content of polymelamine sulfonate equal to 2%, and adding 1% of poly(meth)acrylate, the resistance to flexing (Rf) was measured at 1 hour 30 minutes and 24 hours directly on thin boards fabricated in accordance with the invention, with dimensions L=100 mm, l=75 mm, e=12.5 mm, from compositions in which only the content of Portland cement varies. Expanded polystyrene balls with a particle size range ≦1 mm were added to the binder at the rate of 2% by mass. The results are set out in the table below:

| AMOUNT OF | | Rf AT 1 HOUR | Rf AT 24 |
|---|---|---|---|
| PORTLAND CEMENT | SPECIFIC | 30 MINUTES | HOURS |
| IN BINDER (%) | GRAVITY | (MPa) | (MPa) |
| 60 | 1.05 | 1.46 | 1.70 |
| 64 | 1.07 | 2.10 | 2.26 |
| 67 | 1.02 | 1.30 | 1.61 |
| 69 | 1.07 | 1.37 | 1.79 |

As can be seen, the resistances to flexing are significant from as little as 1 hour 30 minutes.

### Examples 9 and 9a

These examples compare the mechanical performance in compression (Rc) and flexing (Rf) of two compositions 9a and 9 respectively prepared in the presence and in the absence of Li₂CO₃.

The formulations are as follows:

| | |
|---|---|
| binder (100%) | |
| sulfoaluminous clinker 1 | 45% |
| Portland cement CEM I 52.5 | 40% |
| Plaster | 15% |
| additives (% relative to binder) | |
| Cimfluid ML | 1.5% |
| Cimfluid AC 2000 | 0.3% |
| polystyrene balls (≦ 1 mm) | 1.5% |
| Li₂CO₃ | 0% (ex. 9) |
| | 0.5% (ex. 9a) |
| water 30% relative to binder | |

The performance obtained is set out in the following table:

| | EXAMPLE 9 | EXAMPLE 9A WITH |
|---|---|---|
| MEASUREMENT | WITHOUT Li₂CO₃ | Li₂CO₃ |
| SPECIFIC GRAVITY | 9.98 | 1.00 |
| (at 20 min) | | |
| SETTING TIME | <8 min | <8 min |
| Rf (at 20 min) | 1.04 MPa | 1.7 MPa |
| Rc (at 20 min) | 3.3 MPa | 5.8 MPa |
| Rf (at 24 hours) | 1.6 MPa | 1.9 MPa |
| Rc (at 24 hours) | 10.2 MPa | 12.6 MPa |

### Example 10

Polymelamine sulfonate (Cimfluid ML) at a rate of 2% and citric acid at varying rates were added to the cement base composition. The results obtained are set out below:

| | | | | START | | | |
|---|---|---|---|---|---|---|---|
| ADDITIVE | | | TIME | OF | END OF | | |
| x(g) | | | OF | SETTING | SETTING | | |
| | citric | SPREAD | USE | TIME | TIME | Δt₁ | Δt₂ |
| ML* | acid | (mm) | (min) | (min) | (min) | (min) | (min) |
| 2 | 0.4 | 78 | 14.3 | 17.6 | 26.5 | 8.9 | 2.6 |
| 2 | 1 | 65 | 20.3 | 21.8 | 34.4 | 12.6 | 3.0 |
| 2 | 1.5 | 64 | 50.5 | — | — | — | 22.8 |

*ML = Cimfluid ML

The use of citric acid increases the time of use of the composition.

### Example 11

In the composition of example 1, the poly(meth)acrylate was replaced by an additive containing a gluconate (Cimaxtard 101, from Axim), in the following proportions:

ADDITIVE
X (g)

| | Cimaxtard | SPREAD | TIME OF USE | Δt₂ |
|---|---|---|---|---|
| ML* | 101 | (mm) | (min) | (min) |
| 2 | 0.25 | — | 8.5 | 2.0 |
| 2 | 0.50 | — | 13.0 | 2.0 |
| 2 | 1.00 | 120 | 22.0 | 3.5 |
| 2 | 1.5 | — | 23.5 | 4.0 |

*ML = Cimfluid ML

The use of Cimaxtard 101 increases the time of use of the composition without compromising the initial rheology.

### Example 12

Poly(meth)acrylate (Cimfluid AC) alone was added to the cement base composition, in the proportions indicated below:

| AD- | | | START OF | END OF | | |
|---|---|---|---|---|---|---|
| DITIVE | | TIME | SETTING | SETTING | | |
| x(g) | SPREAD | OF USE | TIME | TIME | Δt₁ | Δt₂ |
| AC* | (mm) | (min) | (min) | (min) | (min) | (min) |
| 0.6 | 82 | 7.0 | 7.5 | 14.2 | 6.7 | 1.1 |
| 1 | 186 | 14.4 | 13.5 | 25.5 | 12.0 | 2.0 |
| 2 | 234 | 28.6 | 23.0 | 39.5 | 16.5 | 2.9 |

*AC = Cimfluid 2000 AC

The use of Cimfluid 2000 AC on its own also extends the time of use of the composition, up to approximately 30 minutes. However, note that in the situation where it is possible to obtain a time of use of 28.6 minutes, the value of Δt₁ is higher than that measured with the mixture [ML (2%)−AC (1%)] (see example 7).

FIG. 1 is a diagram illustrating one fabrication method.

A first metered premixture 10 is produced from cement 11, clinker 12, plaster 13 and aggregates 14 such as polystyrene balls.

A second metered premixture 20 is produced from a plasticizer 21 and a retarder 23 to both of which water 22 has been added.

The premixtures 10 and 20 are introduced into a mixer 30; the resulting mixture is taken up by an uptake pump 31 and distributed via a distributor 32 to the entry of an extruder 33; distribution is effected, homogeneously in the transverse direction, between top and bottom facings consisting of sheets in the form of meshes, namely a bottom mesh G1 and a top mesh G2; the bottom mesh G1 rests on a plastics material sheet FP, such as a polyethylene sheet, pulled by a downstream conveyor belt 43 (FIGS. 2 and 3) and sliding on a table 46 disposed on the upstream side of the extruder 33; at the exit from the extruder 33, the board formed to shape in this way is fed to a cutting station 34 where its length and its edges, and thus its width, are cut, advantageously by a water jet.

During the above process, each facing consists of a mesh G1, G2 and/or a web V, VB; the web V covers the mesh G1, G2 over the whole of its width; the web VB is in strip form and covers only the lateral edges of the mesh G2; the lateral edges of the boards are preferably formed by turning over the bottom mesh G1 and then cut straight; the turned over portion of the bottom mesh G1 is covered by the top mesh G2, whether or not associated with a web V; the turned over portion of the bottom mesh G1 covers the top mesh G2, whether or not associated with a web V; the lateral edges of the bottom mesh G1 are associated with a web V, VB.

The cutting is advantageously effected in the overlapping portion.

Part of the extruder 33 is shown diagrammatically in FIGS. 2 to 4. It essentially consists of a table 35 elastically mounted on a frame 36 by means of springs 37, here four coil springs disposed at the four corners of the generally rectangular table 35. The top 38 of the table 35 constitutes the bottom lip of a die 40 disposed transversely and of globally rectangular section, the top lip 39 of which is shown; here the top lip 39 is in the form of a blade and its height is adjustable relative to the bottom lip 38 so that the height of the die 40, and therefore the required thickness of the board, can be adjusted.

A slightly inclined deflector 41 at the entry of the die 40 guides the material toward the die.

The bottom of the table 35 carries at least one vibrator 42, here two vibrators 42. A vibrator 42 consists of an electric motor whose rotor has an adjustable imbalance adapted to produce vibrations, for example.

A continuous board pulled by the conveyor belt 43 is obtained at the exit from the extruder 33, as shown by the arrow F in FIGS. 2 and 3.

Here the axes of the vibrators 42 are parallel to the arrow F; this axis can be oriented in a horizontal plane, as shown in FIG. 5, in which another orientation of the vibrators 42 is shown in chain-dotted outline; it can equally be oriented in a vertical plane, for example the plane of FIG. 2; these orientations favorably influence the homogeneity of the composition in the transverse direction on entering the extruder 33.

Here the die 44 is generally rectangular with the ends 44 slightly converging in the outward direction so that the parallel lateral edges of the resulting board are thinner, as defined in French standard NF P72-302: this facilitates the application of a mastic for jointing two boards side by side, but is not mandatory, of course.

The boards are removed from the conveyor after the operation of distributing the mixture and cutting; the composition according to the invention, the speed of the conveyor belt and the length of the system are such that, at this point, the hydration of the boards is such that each board can be handled.

Boards according to the present invention can have a body of highly varied composition.

The body can be based on semihydrate calcium sulfate and water, for example as described in the document GB-A-2 0553 779; conventional additives can be used, as well as from 0.3 to 3% of glass fibers; the body can also include perlite, vermiculite, a formaldehyde-based or other resin.

The examples described in the document WO-A-91/11321 are also suitable; more generally, here, boards are obtained by mixing lightweight components, such as expanded clays, expanded blast furnace ash, expanded schist, perlite, expanded polystyrene balls, expanded glass balls, with a hydraulic binder such as Portland cement, cement based on magnesium, aluminous cement, gypsum and/or mixtures of some of the above, with or without foaming agents.

To be more precise, good results can be obtained with the following examples.

### Example 13

This composition is of the kind described in the document WO 99/08979.

| Composition | Percentage by weight |
|---|---|
| Semihydrate calcium sulfate | 100 |
| Water | 94-98 |
| Setting accelerator | 1.1-1.6 |
| Starch | 0.5-0.7 |
| Fluidizer | 0.2-0.22 |
| Paper fibers | 0.5-0.7 |
| Setting retarder | 0.07-0.09 |
| Foaming agent | 0.02-0.03 |
| Sodium trimetaphosphate | 0-0.16 |
| Recalcination inhibitor | 0.13-0.14 |

### Example 14

This composition is of the kind described in the document WO 99/14449.

| | General formula | Specific formula |
|---|---|---|
| Composition | Percentage by weight | Percentage by weight |
| Portland | Type I: 30-50 | Type I: 34 ± 2 |
| cement | Type II: 30-50 | |
| | Type III: 30-50 | |
| | Type IV: 30-50 | |
| Aluminous | Blaine specific surface area | Blaine specific |
| cement | from 4000 to 5000: 2-20 | surface area |
| | Blaine specific surface area | 4000 to 5000: 4 ± 2 |
| | from 5000 to 6000: 1-15 | |
| | Sand for mortar: 0-1/16″: | Sand for mortar: |
| | 30-60 | 48% ± 2 |
| | Sand for concrete 0-1/8: | |
| | 30-60 | |
| | Expanded clay: 15-50 | |
| | Expanded schist: 15-50 | |
| | Expanded mining waste: | |
| | 15-50 | |
| | Expanded vermiculite: 2-10 | |
| | Expanded perlite: 2-10 | |
| Polystyrene | Diameter from 0-1/8″ | 1 ± 0.2 |
| Water | Drinking water: 10-30 | 11 ± 5 |
| Air | Generic surfactants 0-2 | 0.015 ± 0.005 |
| entrainment | | |
| agent | | |

### Example 15

This composition is of the kind described in the document U.S. Pat. No. 5,221,386.

| Composition | | Percentage by weight |
|---|---|---|
| Powder | TYPE III Portland cement | 68.1 |
| | Aluminous cement | 17.79 |
| | Blaine specific surface area | |
| | 6000 cm²/g | |
| | Plaster | 5.69 |
| | Lime | 0.57 |
| | Fly ash | 7.84 |
| | Scoria | |
| | Foam | |
| | Expanded polystyrene balls | |
| | Other | |
| | Total | 100 |
| Liquid | Lomar D superplasticizer | 1 |
| | 8% citric acid aqueous | 0.5 |
| | solution | |
| | Water | 98.5 |
| | Total | 100 |
| Mixing rate | Liquid/powder ratio | 0.35 |

FIG. 6 shows partly in section a board according to the invention before its edges are cut; there can be seen therein the bottom mesh G1, the top mesh G2, the thinner edge 44 and the aggregates 14; here, to form the edges of the board, the bottom mesh G1 is folded laterally so that it partially overlaps laterally the top mesh G2.

Note that, in the lower portion of the board, as seen in the figure, a thin region D is free of aggregates 14; this is therefore a densified region, obtained by virtue of the nature of the composition of the board body and extrusion with vibration; this region increases the mechanical strength of the board.

As an alternative, the densified region is an applied deposit consisting of a layer free of aggregates.

FIG. 7 shows the board after cutting the edge 45 along the line C in FIG. 6.

The parallel lateral edges are straight.

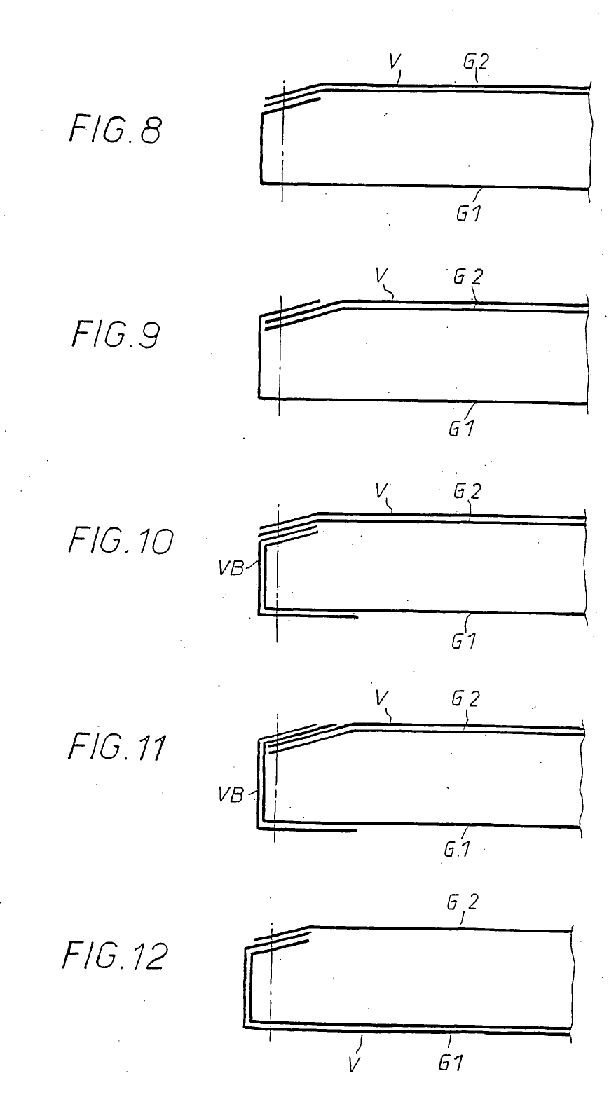

Here also, as shown in FIG. 9, the top mesh G2 can carry, for example have bonded to it, a web V consisting of a glass fiber mat, for example; this kind of web V further increases the mechanical strength of the board; here the web V covers the mesh G2 over the whole of its width.

Other dispositions can be adopted, of course.

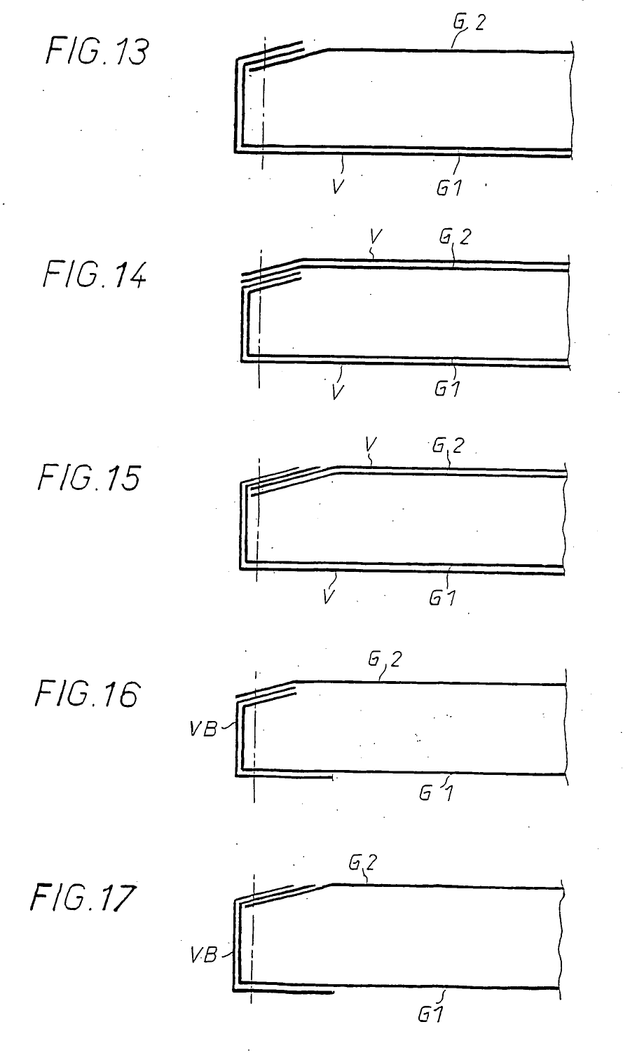

Thus, as shown in FIG. 8, the mesh G2 associated with a web V covers the laterally folded portion of the bottom mesh G1. FIG. 10 is analogous to FIG. 2 except that the bottom mesh G1 is associated with a strip of web VB attached, for example adhesively bonded, along its longitudinal edges so that the top mesh G2, where applicable associated with a web V, covers the folded part of the strip of web VB, which helps to form the edge of the board. FIG. 11 combines the features described with reference to FIGS. 9 and 10, in other words it is the bottom mesh G1 and the strip of web VB that cover the top mesh G2 and its web V. Of course, the bottom mesh G1 could equally carry a web, such as the web V; accordingly, FIGS. 12-15 illustrate situations in which the bottom mesh G1 carries a web V, the remainder being as in FIGS. 8, 9 with a top mesh G2 with no web, FIGS. 12-13, or with a web V, FIGS. 14-15; the mesh G1 is covered by the web V over the whole of its width. FIGS. 16, 17 show a disposition analogous to that of FIGS. 12, 13, in which the web V associated with the bottom mesh G1 has been replaced by a lateral strip of web VB.

The web VB in the form of a strip covers only the lateral edges of the mesh G1 and/or G2; accordingly, the top mesh G2 at least partly covers a portion of the bottom mesh G1, whether associated or not with a web V, VB; alternatively, the top mesh G2 is at least partly covered by a portion of the mesh G1, whether associated or not with a web V, VB.

Alternatively, the top lip 39 is the bottom generatrix of a cylindrical roller mounted to rotate about a transverse axis.

In a variant that is not shown, the top and/or bottom facing is of cardboard, substituted for the mesh and/or the web.

A layer of latex type polymer emulsion (or one with organic solvent) is advantageously deposited on one or both faces of the board; thus a protective film is obtained on the surface of the board. The protective film in particular reduces the permeability of the board, improves the surface appearance, facilitates the adhesion of any covering, such as tiles, and to some degree limits dimensional variations of the board. The protective film can be deposited by surface spraying, by coating with rollers, by impregnating the mesh or meshes, whether or not associated with a web, by passage through a bath or by passage between rollers.

1.-26. (cancelled).

27. A method of fabricating a board based on a binder such as plaster or cement, characterized in that it includes the steps of:
a) mixing a composition intended to form the board body with water;
b) depositing the mixture on a moving support, which is driven continuously by a conveyor belt, said mixture passing through an extruder forming a board, said extruder being subjected to vibrations;
c) cutting the board obtained at least to length.

28. A method according to claim 27, characterized in that, in step c), the board is cut to length and to width.

29. A method according to claim 27, characterized in that the deposition of step b) is carried out on a bottom facing.

30. A method according to claim 29, characterized in that the deposit of step b) is covered with a top facing.

31. A method according to claim 29, characterized in that the facing consists of a mesh (G1, G2) and/or a web (V, VB).

32. A method according to claim 29, characterized in that the mesh (G1, G2) is of glass fibers.

33. A method according to claim 31, characterized in that the web (V) covers the mesh (G1, G2) over the whole of its width.

34. A method according to claim 31, characterized in that the web (VB) is in the form of a strip and covers only the lateral edges of the mesh (G2).

35. A method according to claim 31, characterized in that the web (V, VB) is a mat, preferably of glass fibers.

36. A method according to claim 27, characterized in that, in step c), the cutting method is cutting with a water jet.

37. A method according to claim 29, characterized in that the lateral edges of the boards are formed beforehand by turning over the bottom mesh (G1) and then cut straight.

38. A method according to claim 37, characterized in that the turned over portion of the bottom mesh (G1) is covered by the top mesh (G2) whether or not it is associated with a web (V).

39. A method according to claim 37, characterized in that the turned over portion of the bottom mesh (G1) covers the top mesh (G2) whether or not it is associated with a web (V).

40. A method according to claim 38, characterized in that at least the lateral edges of the bottom mesh (G1) are associated with a web (V, VB).

41. A method according to claim 37, characterized in that the cutting is effected in the overlapping portion.

42. A method according to claim 27, characterized in that operation b) is carried out in such a way that two of the lateral edges of the boards are thinner.

43. A method according to claim 29, characterized in that the top and/or bottom facing is of cardboard.

44. An extruder for implementing the method according to claim 27, of the kind including a transverse extrusion die (40), characterized in that said die (40) is at least in part subjected to vibrations.

45. An extruder according to claim 44, characterized in that the die (40) has a top lip and a bottom lip (38) which carries on its bottom face at least one vibrator (42).

46. An extruder according to claim 45, characterized in that the distance between the top lip (39) and the bottom lip (38) of the die (40) is adjustable.

47. An extruder according to claim 45, characterized in that the axis of the vibrator (42) can be oriented horizontally.

48. An extruder according to claim 45, characterized in that the axis of the vibrator (42) can be oriented vertically.

49. An extruder according to claim 44, characterized in that the extrusion die (40) has a generally rectangular shape with the ends (44) of the facing lengths converging slightly in the outward direction.

50. A plaster or cement based board having a top and bottom facings, each of the facings comprising at least a layer of mesh (G1, G2) and/or a web (V, VB), the board having longitudinal edges devoid of mesh or web.

51. A plaster or cement based board according to claim 50, characterized in that the board is cement based.

52. A plaster or cement based board according to claim 50, characterized in that the top and/or bottom facing comprises at least two layers, immediately adjacent the longitudinal edges, including at least one layer of mesh (G1, G2).

53. A plaster or cement based board according to claim 50, characterized in that the top and/or bottom facing comprises at least two layers, immediately adjacent the longitudinal edges, including at least one layer of web (V, VB).

54. A plaster or cement based board according to claim 50, characterized in that the top and/or bottom facing comprises at least three layers, immediately adjacent the longitudinal edges, including at least two layers of mesh (G1, G2), and at least one layer of web (V, VB).

55. A plaster or cement based board according to claim 50, characterized in that the top and/or bottom facing comprises at least three layers, immediately adjacent the longitudinal edges, including at least two layers of web (V, VB), and at least one layer of mesh.

56. A plaster or cement based board according to claim 50, characterized in that the top and bottom facings both comprise at least two layers immediately adjacent the longitudinal edges, at least one of the layers being of mesh (G1, G2).

57. A plaster or cement based board according to claim 50, characterized in that the top and bottom facings both comprise at least two layers, immediately adjacent the longitudinal edges, at least one of the layers being of web (V, VB).

58. A plaster or cement based board according to claim 50, characterized in that the top facing has at least three layers immediately adjacent the longitudinal edges.

59. A plaster or cement based board according to claim 58, characterized in that the top facing of the board adjacent the longitudinal edges is thinned and oblique.

60. A plaster or cement based board according to claim 50, characterized in that the top and bottom facings both comprise an inner layer of mesh (V, VB).

61. A plaster or cement based board according to claim 50, a lower portion of the board, having a densified thin region D.

62. A plaster or cement based board according to claim 61, characterized in that the board comprises, in addition to a cementitious binder, lightweight aggregate (14), said densified thin region being free of aggregate.

63. Use of the board according to claim 50, in which the binder is a cementitious binder, to form or cover walls, partition walls, floors or roofs, inside or outside buildings, such as industrial kitchens, agriculture-foodstuffs laboratories, showers, bathrooms, pools or swimming pools, and/or rooms frequently washed with a water jet, such as rooms of agricultural buildings or industrial slaughterhouses.

64. Use of the board according to claim 50, in which the binder is based on plaster, to form or cover walls or partition walls.
